(19) United States
(12) Patent Application Publication
(10) Pub. No.: US 2008/0037557 A1
(43) Pub. Date: Feb. 14, 2008

(54) Vpn Getaway Device and Hosting System

(75) Inventors: Norihito Fujita, Tokyo (JP); Yuuichi Ishikawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-ku, Tokyo (JP)

(21) Appl. No.: 11/577,001

(22) PCT Filed: Oct. 13, 2005
(86) PCT No.: PCT/JP05/18860

§ 371 Date: Apr. 10, 2007

(30) Foreign Application Priority Data
Oct. 19, 2004 (JP) 2004-304254

(51) Int. Cl. H04L 12/28

(52) U.S. Cl. 370/395.53

(57) ABSTRACT

A VPN gateway (A11) includes a WAN interface (A111) for exchanging packets with client nodes (C1, C2, D1, D2) via IPsec tunnels (B11-B14) set on the WAN side, a LAN interface (A112) for exchanging packets with server nodes (A131-A136) connected to the LAN side, a session relay unit (A114) for temporarily terminating a first communication session to be set for a sever node from a client node, and setting a second communication session that relays the first communication session to the server node, and an SSL processor (A116) for making the second communication session into an SSL. This arrangement makes it possible to dynamically allocate the servers in a data center (A1) to a VPN, permit only an authenticated server to communicate with another node in the VPN, and prevent wiretapping and tampering of communication performed by the server.

### TECHNICAL FIELD

The present invention relates to a VPN gateway device and hosting system and, more particularly, to a VPN gateway device that terminates a VPN tunnel set on the WAN side, and a hosting system including this VPN gateway device.

### BACKGROUND ART

A hosting service that lends resources such as a server and network device to users and the like is one of services provided by data center companies. A system on the data center side that provides this hosting service is called a hosting system.

Reference 1 (Japanese Patent No. 3491828) and reference 2 (Japanese Patent Laid-Open No. 2003-32275) describe an example of the conventional hosting systems. In this hosting system described in these references, a VPN (Virtual Private Network) gateway is placed in a data center (the VPN gateway is also referred to as a VPN router in references 1 and 2). The VPN gateway establishes a VPN tunnel such as an IPsec tunnel or L2TP tunnel to the outside, and accommodates a VPN. A VLAN logically separates the segment of the LAN (Local Area Network) side of the VPN gateway, and the VPN gateway associates the accommodated VPN with the VLAN. Combinations of servers to be allocated to the VPN can be dynamically changed by dynamically changing the settings of the VLAN to which servers installed in the data center connect and the settings of the association of the VPN with the VLAN in the VPN gateway.

In this hosting system, a server in the data center is not directly accommodated in the VPN by the VPN tunnel but accommodated in a VPN formed by the VPN tunnel via the VLAN connecting to the VPN gateway. With this arrangement, servers can be dynamically allocated to the VPN by only changing the VLAN settings in the data center server and switch and the settings of the association of the VPN with the VLAN, without changing the settings of the VPN tunnel.

### DISCLOSURE OF INVENTION

### Problems to be Solved by the Invention

When the server is accommodated in the VPN by directly terminating the VPN tunnel, misrepresentation as a server can be detected and prevented by using a VPN tunnel authentication mechanism. However, when the VLAN exists between the server and VPN tunnel as in the conventional hosting system, the VPN tunnel authentication mechanism cannot be used for the server. Therefore, even a false server can communicate with a node in a VPN associated with a VLAN if the false server can connect to the VLAN. Thus, the conventional hosting system has the problem that even a false server can be accommodated in a VPN.

In addition, wiretapping of data communicated on the VPN tunnel can be prevented because the data is encrypted by AES (Advanced Encryption Standard) or the like, and tampering of the data can also be prevented because a digital signature is formed using SHA-1 or the like. When the VLAN exists between the server and VPN tunnel as in the conventional hosting system, however, data is communicated as a plain text without any encryption or digital signature on the VLAN, so the data is defenseless against wiretapping and tampering. As described above, the conventional hosting system has the problem that wiretapping and tampering can occur on communication performed by servers.

The present invention has been made to solve the above problems, and has as its object to permit only an authenticated server to communicate with another node in a VPN in a hosting system in which servers connect to the VPN across a LAN.

It is another object of the present invention to prevent wiretapping and tampering on communication performed by servers in a hosting system in which the servers connect to a VPN across a LAN.

### Means for Solving the Problems

To achieve the above objects, a VPN gateway device of the present invention is characterized by comprising a WAN interface which exchanges packets with a client node via a VPN tunnel set on a WAN side, a LAN interface which exchanges packets with a server node connected to a LAN side, a session relay unit which temporarily terminates a first communication session to be set for the server node from the client node, and sets, for the server node, a second communication session which relays the first communication session, and an SSL processor which makes the second communication session set by the session relay unit into an SSL.

Also, a VPN gateway device of the present invention is characterized by comprising a WAN interface which exchanges packets with a client node via a first VPN tunnel set on a WAN side, a LAN interface which exchanges packets with a server node connected to a LAN side, and a packet relay unit which relays and transfers to the server node a packet addressed from the client node to the server node and received by the WAN interface, via a second VPN tunnel set between the LAN interface and the server node.

### EFFECTS OF THE INVENTION

In the present invention, a session communicated via a VPN tunnel on the WAN side of a VPN gateway device is relayed in the form of an SSL in an interval from the VPN gateway device to a server node on the LAN side.

Also, in the present invention, a packet communicated via a VPN tunnel on the WAN side of a VPN gateway device is relayed via a VPN tunnel in an interval from the VPN gateway device to a server node on the LAN side.

The above arrangements make it possible to dynamically allocate servers in a data center to a VPN, prevent the allocation of a false server to the VPN, permit only an authenticated server to communicate with another node in the VPN, and prevent wiretapping and tampering of communication performed by the server.

### BRIEF DESCRIPTION OF DRAWINGS

FIG. 1 is a block diagram showing the arrangement of the first embodiment of the present invention;

FIG. 2 is a block diagram showing the main parts of a session relay unit shown in FIG. 1;

FIG. 3 is a flowchart showing the operation of the first embodiment of the present invention;

FIG. 4 is a block diagram showing the arrangement of the second embodiment of the present invention;

FIG. 5 is a block diagram showing the main parts of a packet relay unit shown in FIG. 4;

FIG. 6 is a flowchart showing the operation of the second embodiment of the present invention; and

FIG. 7 is a block diagram showing the arrangement of the third embodiment of the present invention.

### BEST MODE FOR CARRYING OUT THE INVENTION

Embodiments of the present invention will be explained in detail below with reference to the accompanying drawings.

### First Embodiment

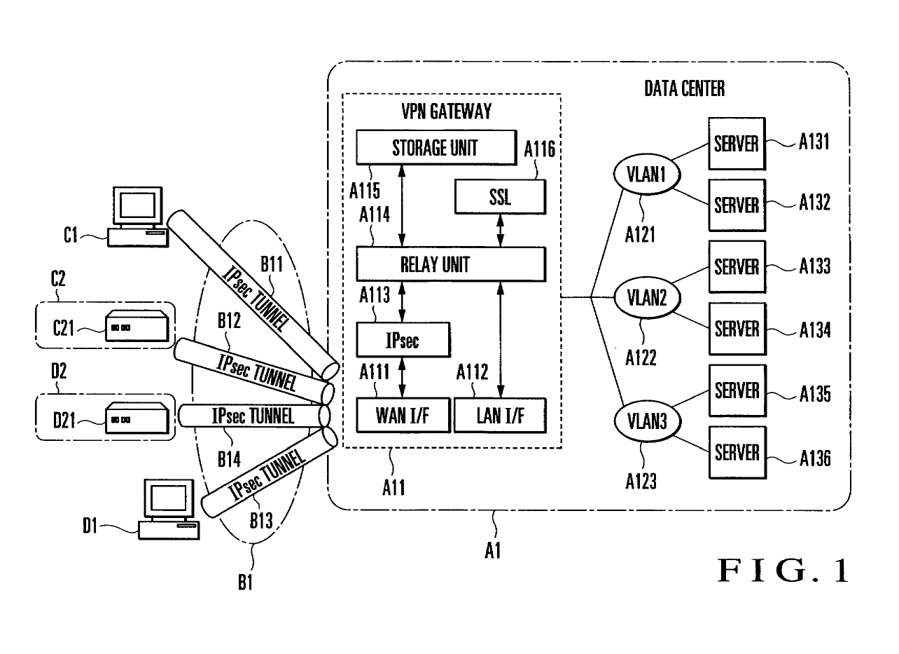

Referring to FIG. 1, the first embodiment of the present invention comprises a data center 1A, a backbone network B, terminals C1 and D1, and VPN points C2 and D2.

A VPN gateway A11 installed in the data center A1 is connected to the terminal C1, VPN point C2, terminal D1, and VPN point D2 via IPsec tunnels B11 to B14 across the backbone network B1. In the connections to the VPN points C2 and D2, VPN gateways C21 and D21 respectively installed in the VPN points C2 and D2 terminate the IPsec tunnels. Examples of the backbone network B1 are the Internet and data communication networks such as an IP-VPN and wide area Ethernet (registered trademark). Although this embodiment will explain the case that IPsec is used as a VPN tunnel, the present invention is similarly applicable to the case that L2TP (Layer Two Tunneling Protocol) or the like is used.

The data center A1 comprises the VPN gateway A11 described above, VLANs A121 to A123, and servers A131 to A136. On the LAN side, the VPN gateway A11 accommodates three VLANs, i.e., the VLANs A121 to A123; the servers A131 and A132 are connected to the VLAN A121, the servers A133 and A134 are connected to the VLAN A122, and the servers A135 and A136 are connected to the VLAN A123. The servers A131 to A136 are information processors that provide services such as HTTP (Hyper Text Transfer Protocol) and SIP (Session Initiation Protocol) to clients in the VPN.

The VPN gateway A11 comprises a WAN (Wide Area Network) interface (WAN I/F) A111, LAN interface (LAN I/F) A112, IPsec processor (VPN processor) A113, session relay unit A114, session relay table storage unit A115, and SSL processor A116.

The WAN interface A111 is a communication interface that exchanges packets with the backbone network B1 side (WAN side).

The LAN interface A112 is a communication interface that exchanges packets with nodes (in this embodiment, the servers A131 to A136) in the data center A1.

The IPsec processor A113 terminates the IPsec tunnels B11 to B14 set across the backbone network B1. The IPsec tunnels B11 to B14 each correspond to a VPN. In this embodiment, the IPsec tunnels B11 and B12 are used in VPN-A, and the IPsec tunnels B13 and B14 are used in VPN-B. The IPsec processor A113 has a function of communicating with the LAN side via the session relay unit A114, and also has a function of encrypting and decrypting packets to be exchanged with the WAN side.

The session relay unit A114 relays, on the transport layer level, packets transmitted and received by the VPN gateway A11. The relay method is determined by referring to a session relay table stored in the session relay table storage unit A115. For example, when receiving, from the terminal C1 having an IP address 10.1.0.1, an HTTP session addressed to the server A131 having an address 10.0.0.1, the session relay unit A114 temporarily terminates a TCP connection (first communication session) corresponding to the session, and sets a TCP connection (second communication session) that relays the connection to the server A131 as an actual destination. In this case, transparent relay is performed so that the terminal C1 and server A131 as the source and destination, respectively, of the HTTP session do not care about the relay of the TCP connection. That is, when relaying a session set between the terminal C1 and server A131, the source and destination IP addresses of a packet communicated in an interval of terminal C1 [symbol] VPN gateway A11 and an interval of VPN gateway A11 [symbol] server A131 remain the same.

The session relay unit A114 also has a function of making a TCP connection to be relayed into an SSL (Secure Socket Layer) on the LAN side of the connection. For example, when setting an HTTP session between the terminal C1 and server A131, data is exchanged as it is converted into HTTPS (HTTP over SSL) between the VPN gateway A11 and server A131. The process of making an SSL is performed via the SSL processor A116.

The session relay table stored in the session relay table storage unit A115 is a table in which TCP connection relay methods in the session relay unit A114 are registered. Table 1 below shows an example of the table.

TABLE 1

| | WAN-side | Destination | Permitted | | |
|---|---|---|---|---|---|
| | IPsec | address | destination | Making of | Certificate |
| VPN-ID | tunnels | (VLAN-ID) | ports | SSL | issuer CN |
| A | Tunnels | 10.0.0/24 | 80, 5060 | Yes | vpn-a's |
| | B11 & B12 | (VLAN 1) | | | admin |
| | | | any | No | — |
| | | 10.0.1/24 | 80 | Yes | default |
| | | (VLAN 2) | 23 | No | — |
| B | Tunnels | 192.168.0/24 | 80, 5060 | Yes | vpn-b's |
| | B13 & B14 | (VLAN 3) | | | admin |
| | | | any | No | — |
| . . . | . . . | . . . | . . . | . . . | . . . |

In this session relay table shown in Table 1, the entries of session relay methods in the two VPNs, i.e., VPN-A and VPN-B are registered.

Communication is performed via the tunnels B11 and B12 on the WAN side of the VPN gateway A11 in VPN-A, and performed via the tunnels B13 and B14 in VPN-B. Also, on the LAN side of the VPN gateway A11, VLAN 1 and VLAN 2 correspond to VPN-A, and VLAN 3 corresponds to VPN-B. A VLAN corresponding to each session is determined in accordance with the destination IP address. Sessions having destination IP addresses 10.0.0/24 and 10.0.1/24 are transferred to VLAN 1 and VLAN 2. A session having a destination address 192.168.0/24 is transferred to VLAN 3.

For VLAN 1, relay of sessions corresponding to all destination port numbers (destination information) represented by “any” is permitted; only sessions whose destination port numbers (destination information) are 80 and 5060 are relayed as SSL sessions, and sessions corresponding to other port numbers are directly relayed. In an SSL interval, only a server having a certificate the CN (Common Name) of the issuer of which is “vpn-a's admin” is permitted to connect.

For VLAN 2, relay of sessions whose destination ports are 80 and 23 is permitted; a session whose destination port is 80 is relayed in the form of an SSL, and a session whose destination port is 23 is directly relayed. In an SSL interval, only a server having a certificate the CN (Common Name) of the issuer of which is a default route verifying organization (e.g., Verisign or Microsoft) is permitted to connect.

For VLAN 3, relay of sessions corresponding to all destination port numbers is permitted; only sessions whose destination ports are 80 and 5060 are relayed in the form of an SSL, and sessions corresponding to other port numbers are directly relayed. In an SSL interval, only a server having a certificate the CN (Common Name) of the issuer of which is “vpn-b's admin” is permitted to connect.

The SSL processor A116 has a function of making a session relayed by the session relay unit A114 into an SSL in an interval on the LAN side of the VPN gateway A11. The SSL processor S116 also has a function of checking whether a server that connects to an SSL session is an authorized server. This check is done by checking whether a server certificate presented by a server in an SSL handshake protocol is issued by an issuer corresponding to the CN registered in the session relay table.

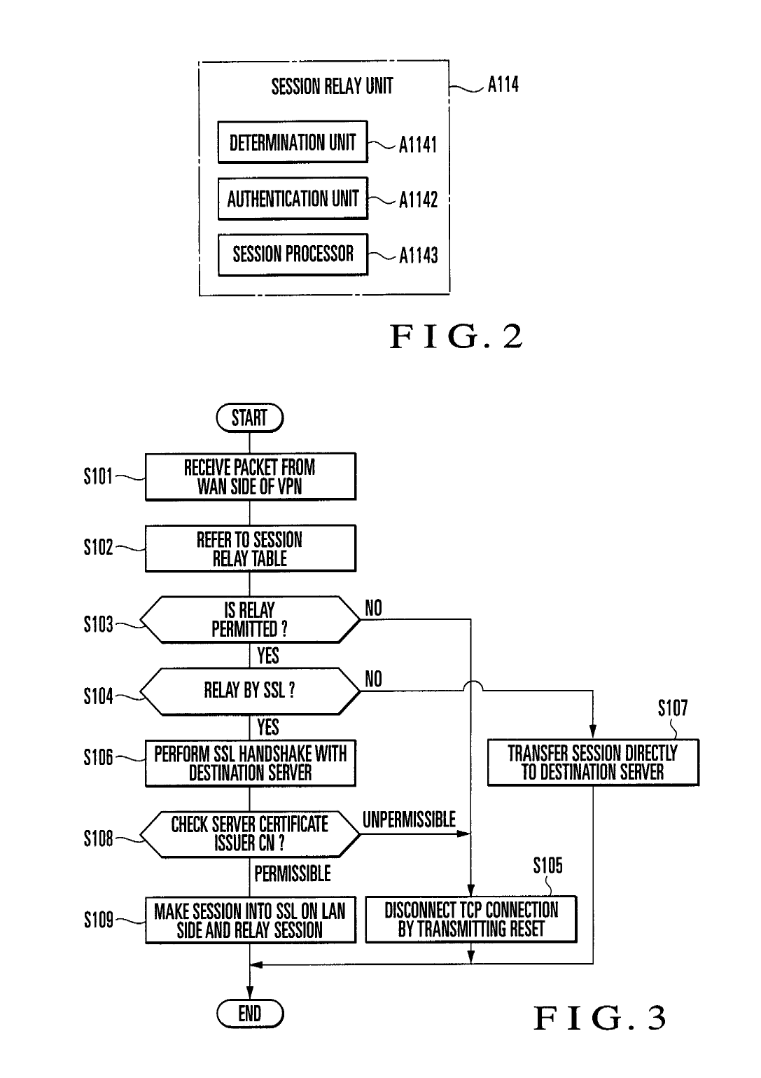

The session relay unit A114 will be explained in more detail below with reference to FIG. 2. As shown in FIG. 2, the session relay unit A114 has a determination unit A1141, authentication unit A1142, and session processor A1143.

The determination unit A1141 refers to the session relay table stored in the session relay table storage unit A115, and determines whether relay of a session received by the session relay unit A114 is permitted on the basis of the destination port number of the session. If relay of the session is permitted, the determination unit A1141 refers to the session relay table, and determines whether to make a session for relaying the session of interest into an SSL on the basis of the destination port number of the session of interest. More specifically, the determination unit A1141 performs processes in steps S102 to S104 of FIG. 3 to be described later.

If the determination unit A1141 determines to make the session into an SSL, the authentication unit A1142 performs SSL handshake with a destination server of the recession received by the session relay unit A114, and authenticates the destination server on the basis of the issuer of a server certificate transmitted from the destination server in this SSL handshake. More specifically, the authentication unit A1142 performs processes in steps S106 and S108 of FIG. 3 to be described later.

If the determination unit A1141 determines that relay of the session is not permitted, the session processor A1143 disconnects the session by performing TCP resetting on it. If the determination unit A1141 determines that relay of the session is permitted, the session processor A1143 sets a session for relaying the session of interest. Also, if the determination unit A1141 determines to make no SSL, the session processor A1143 does not make the session for relaying the session of interest into an SSL; if the determination unit A1141 determines to make an SSL, the session processor A1143 causes the SSL processor A116 to make the session for relaying the session of interest into an SSL. Furthermore, if the authentication of the destination server is unsuccessful, the session processor A1143 disconnects the session of interest and the session for relaying it by performing TCP resetting on them. More specifically, the session processor A1143 performs processes in steps S105, S107, and S109 of FIG. 3 to be described later.

An operation in which the VPN gateway A11 relays a session between the WAN side and LAN side in this embodiment will be explained in detail below with reference to FIG. 3.

First, the VPN gateway A11 receives a packet from the WAN interface A111 side. The packet is transferred to the IPsec processor A113 and decrypted, and the decrypted packet is transferred to the session relay unit A114 to read out source and destination IP addresses and source and destination port numbers (step S101 of FIG. 3).

If the packet does not correspond to a currently active session, the session relay unit A114 identifies the packet as a new session, and determines a method of processing the session by referring to the session relay table stored in the session relay table storage unit A115 (step S102). More specifically, on the basis of the ID of a VPN corresponding to the packet, the destination IP address, and the destination port number, the session relay unit A114 determines the ID of a VLAN to which the session is to be transferred and determines whether to relay the session. An explanation will be made by taking as an example the case that the VPN gateway A11 receives a packet corresponding to an HTTP message (port 80) to the server A131 having an IP address 10.0.0.1 from the terminal C1 having an IP address 10.1.0.1 via the tunnel B11, and the session relay table shown in Table 1 is used as a session relay method.

The session relay unit A114 refers to, in the session relay table, an entry concerning VPN-A as the ID of the VPN corresponding to the packet, and determines that the transfer destination is VLAN 1 on the basis of the destination IP address of the packet. In addition, the session relay unit A114 confirms a destination port number permitted to relay a session to VLAN 1 by referring to the session relay table, and determines whether relay of the session is permitted (step S103). For an HTTP message, the destination port number is 80 that is included in the range of 80, 5060, and “any” as the destination port numbers permitted to relay a session, so the session relay unit A114 determines that relay of the session is permissible (relay is unconditionally permitted if there is “any”).

If the session relay unit A114 determines in step S103 that relay of the session is permissible, the session relay unit A114 then refers to the session relay table and determines whether to relay the session by making it into an SSL (step S104). For an HTTP message, the destination port number is 80 that is included in destination ports for SSL relay, so the session relay unit A114 determines to relay the session in the form of an SSL.

If the session relay unit A114 determines that relay of the session is unpermissible, the session relay unit A114 transmits, to the transmission source of the session, a packet that resets a TCP connection corresponding to the session (TCP resetting), thereby disconnecting the session (step S105).

If the session relay unit A114 determines to relay the session in the form of an SSL in step S104, the session relay unit A114 performs SSL handshake with the destination of the session via the SSL processor A116 (step S106).

If the session relay unit A114 determines not to relay the session in the form of an SSL in step S104, the session relay unit A114 does not make the session into an SSL, and directly relays it to the destination server (step S107). In this case, the session relay unit A114 can relay the session by temporarily terminating the TCP connection corresponding to the session, or can simply transfer packets by directly establishing an end-to-end TCP connection without terminating it.

In the SSL handshake performed in step S106, a server's certificate is transmitted to the VPN gateway A11 by a Server Certificate message. The session relay unit A114 receives the certificate transmitted from the server via the SSL processor A116, compares the issuer CN of the certificate with the entry registered in the session relay table, and checks whether the certificate is permissible, thereby authenticating the server (step S108).

If the session relay unit A114 determines in step S108 that the server certificate is permissible, i.e., the authentication of the server is successful, the session relay unit A114 relays the session by making it into an SSL on the LAN side (step S109). After that, communication is performed in this session by encrypting data by an IPsec tunnel on the WAN side of the VPN gateway A11 and encrypting data by an SSL on the LAN side.

If the session relay unit A114 determines in step S108 that the server certificate is unpermissible, i.e., the authentication of the server is unsuccessful, the session relay unit A114 transmits a packet that resets the corresponding TCP connection (TCP resetting) to the transmission source of the session and the server, thereby disconnecting the session (step S105). That is, the session relay unit A114 disconnects the session to be set for the server from the terminal C1 and the session for relaying this session.

The foregoing is an explanation of the operation of relaying a session between the WAN side and LAN side of the VPN gateway A11 of this embodiment.

This embodiment has been explained by assuming that the data center A1 accommodating the servers A131 to A136 exists in a single point. However, it is also possible to carry out the embodiment even in the form of a distributed data center in which a plurality of data centers are connected by dedicated lines or a wide area Ethernet (registered trademark) to emulate a system in which geographically scattered servers are virtually installed in one data center.

The effects of this embodiment will be explained below.

In this embodiment, a session communicated via a VPN tunnel such as IPsec or L2TP set to form a VPN on the WAN side of the VPN gateway A11 is relayed in the form of an SSL in an interval from the VPN gateway A11 to a server on the LAN side. Since an SSL is used in an interval in which no conventional system can perform authentication and encryption by a VPN tunnel, misrepresentation as a server and wiretapping and tampering of communication are impossible. This makes it possible to solve the conventional problem, i.e., to prevent misrepresentation as a server and wiretapping and tampering of communication performed by a server.

Also, this embodiment does not force any client such as the terminal C1 to care about the use of an SSL in a session established between the client and a server. That is, since the client communicates with the server by using a normal protocol such as HTTP or SIP (Session Initiation Protocol) that is not an SSL, an application can be executed without particularly making it correspond to an SSL. The server side must support an SSL in order to use it in a session with the client. However, since the server can use a universal SSL lapper such as stunnel (http://stunnel.org/) provided as free software, the server can perform SSL communication even if an application executed on the server does not directly support an SSL. Accordingly, SSL communication can be carried out by using a versatile server and client.

### Second Embodiment

The second embodiment of the present invention will be explained in detail below with reference to the accompanying drawings.

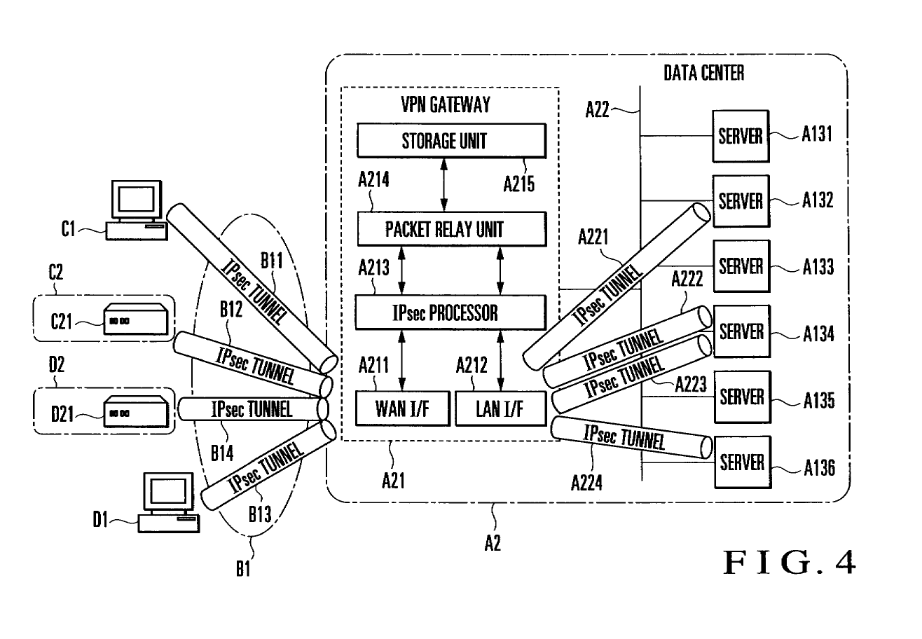

Referring to FIG. 4, the main difference of the second embodiment of the present invention from the first embodiment of the present invention is that a VPN gateway A21 having a function of setting IPsec tunnels between it and servers A131 to A136 is used instead of the VPN gateway A11.

A data center A2 comprises the VPN gateway A21, a LAN A22, and the servers A131 to A136. The LAN A22 accommodates the servers A131 to A136.

The VPN gateway A21 comprises a WAN interface (WAN I/F) A211, LAN interface (LAN I/F) A212, IPsec processor (VPN processor) A213, packet relay unit A214, and packet relay table storage unit A215.

The WAN interface A211 and LAN interface A212 have functions equal to those of the WAN interface A111 and LAN interface A112 of the VPN gateway A11 of the first embodiment.

The IPsec processor A213 has a function of encrypting and decrypting, by using IPsec, packets transmitted and received via the LAN interface A212, in addition to the functions of the IPsec processor A113 of the VPN gateway A11 of the first embodiment.

FIG. 4 shows an example in which IPsec tunnels A221 to A224 are set between the VPN gateway A21 and servers A132, A134, A134, and A136. The IPsec tunnels A222 and A223 are set for the same server A134, but associated with different VPNs. When a plurality of VPNs exist as in this case, a plurality of IPsec tunnels associated with these VPNs are set for the same server so as to accommodate it in the plurality of VPNs.

Also, these IPsec tunnels need not be in a state in which IPsec SA (Security Associates) is actually established; the IPsec tunnels may also be set when packets to be transmitted and received by using these IPsec tunnels are detected. In this case, when the WAN side has received a packet, the IPsec processor A213 sets an IPsec tunnel on the LAN side. If no packet flows for a predetermined time, no SA is established.

The packet relay unit A214 has a function of relaying and transferring packets between IPsec tunnels B11 to B14 set on the WAN side of the VPN gateway A21 and the tunnels A221 to A224 set on the LAN side. The packet relay unit A214 determines the relay/transfer method by referring to a packet relay table stored in the packet relay table storage unit A215.

The packet relay table is a table that the packet relay unit A214 refers to when determining a relay method during packet relay. Table 2 below shows an example of the table.

TABLE 2

| | | | Permitted | | |
|---|---|---|---|---|---|
| | WAN-side IPsec | Destination | destination | LAN-side | Certificate |
| VPN-ID | tunnels | IP address | ports | IPsec Tunnel | issuer CN |
| A | Tunnels B11 & B12 | 10.0.0.2 | 80, 5060 | Tunnel A221 | vpn-a's admin |
| | | 10.0.1.2 | any | Tunnel A223 | vpn-a's admin |
| B | Tunnels B13 & B14 | 192.168.0.2 | 80 | Tunnel A222 | vpn-b's admin |
| | | 192.168.0.3 | any | Tunnel A224 | vpn-b's admin |
| . . . | . . . | . . . | . . . | . . . | . . . |

In this packet relay table shown in Table 2, the entries of packet relay methods in two VPNs, i.e., VPN-A and VPN-B are registered. Tunnels corresponding to the these VPNs on the WAN side of the VPN gateway A21 are the same as in the session relay table shown in Table 1. On the LAN side of the VPN gateway A21, the IPsec tunnels A221 and A223 correspond to VPN-A, and the IPsec tunnels A222 and A224 correspond to VPN-B.

In this table, a packet received from the IPsec tunnel corresponding to VPN-A on the WAN side is relayed and transferred on the basis of the destination IP address and destination port number of the packet; if the destination IP address is 10.0.0.2 and the destination port number is 80 or 5060, the packet is relayed and transferred to a server (the server A132) connected via the IPsec tunnel A221. If the destination IP address is 10.0.1.2 (the destination port number can have any number (“any”)), the packet is relayed and transferred to a server (the server A134) connected via the IPsec tunnel A223. Each IPsec tunnel is permitted to connect to only a server having a certificate the CN of the issuer of which is “vpn-a's admin”. Although an operation of authenticating a server on the basis of a certificate will be explained below, a server may also be authenticated by using a preset password (Pre-Shared Key) or the like.

A method of relaying packets received from the IPsec tunnels corresponding to VPN-B on the WAN side is the same as that for VPN-A.

In this embodiment, the server A134 corresponds to the two VPNs, i.e., VPN-A and VPN-B. Therefore, the server A134 can provide services as a server usable from these two VPNs by selectively using the IPsec tunnels corresponding to the two VPNs.

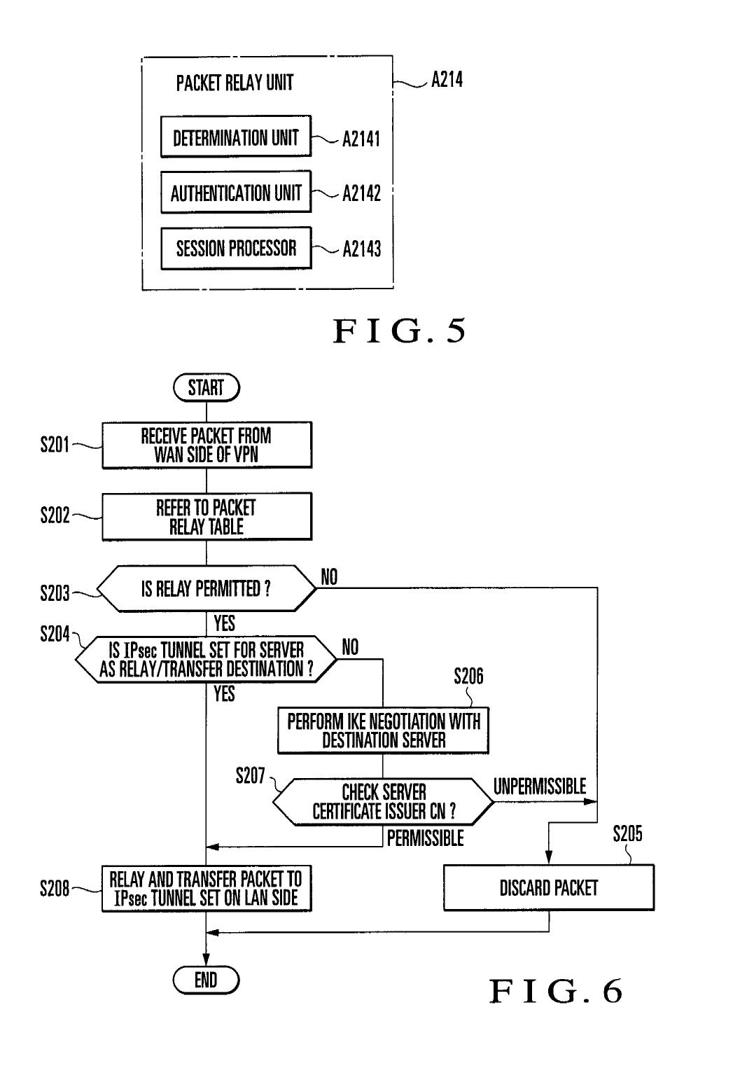

The packet relay unit A214 will be explained in more detail below with reference to FIG. 5. As shown in FIG. 5, the packet relay unit A214 has a determination unit A2141, authentication unit A2142, and session processor A2143.

The determination unit A2141 refers to the packet relay table stored in the packet relay table storage unit A215, and determines whether relay of a packet received by the WAN interface A211 is permitted on the basis of the destination IP address and destination port number (destination information) of the packet. More specifically, the determination unit A2141 performs processes in steps S202 and S203 of FIG. 6 to be described later.

In a protocol procedure for setting an IPsec tunnel on the LAN side, the authentication unit A2142 authenticates a destination server on the basis of the issuer of a server certificate transmitted from the destination server. More specifically, the authentication unit A2142 performs a process in step S207 of FIG. 6 to be described later.

If the determination unit A2141 determines that relay of the packet is not permitted, and if the authentication of the destination server is unsuccessful, the session processor A2143 discards the packet received by the WAN interface A211; in other cases, the session processor A2143 relays and transfers the packet. More specifically, the session processor A2143 performs processes in steps S205 and S208 of FIG. 6 to be described later.

An operation in which the VPN gateway A21 relays a packet between the WAN side and LAN side in this embodiment will be explained in detail below with reference to FIG. 6.

First, the VPN gateway A21 receives a packet from the WAN interface A211 side. The packet is transferred to the IPsec processor A213 and decrypted, and the decrypted packet is transferred to the packet relay unit A214 to read out source and destination IP addresses and source and destination port numbers (step S201 in FIG. 6).

On the basis of the readout source and destination IP addresses and source and destination port numbers, the packet relay unit A214 determines a method of processing the packet by referring to the packet relay table stored in the packet relay table storage unit A215 (step S202). More specifically, on the basis of the ID of a VPN corresponding to the packet, the destination IP address, and the destination port number, the packet relay unit A214 determines an IPsec tunnel on the LAN side to which the packet is to be transferred, and determines whether to relay the packet. An explanation will be made by taking as an example the case that the VPN gateway A21 receives a packet corresponding to an SIP message (port 5060) to the server A132 having an IP address 10.0.0.2 from a terminal C1 having an IP address 10.1.0.1 via the tunnel B11, and the packet relay table shown in Table 2 is used as a packet transfer method.

The packet relay unit A214 refers to, in the packet relay table, an entry concerning VPN-A as the ID of the VPN corresponding to the packet, and determines whether relay of the packet is permitted on the basis of the destination IP address and destination port number of the packet (step S203). For an SIP message, the destination address is 10.0.0.2 and the destination port is 5060, so the packet relay unit A214 determines that relay of the packet is permissible.

If the packet relay unit A214 determines in step S203 that relay and transfer of the packet are permissible, the packet relay unit A214 then determines whether the LAN-side IPsec tunnel to which the packet is to be transferred has already been established (step S204).

If it is determined in step S203 that relay and transfer of the packet are unpermissible, the VPN gateway S12 discards the packet (step S205).

If it is determined in step S204 that the LAN-side IPsec tunnel to which the packet is to be transferred has not been established yet, the IPsec processor A213 performs IKE (Internet Key Exchange) negotiation to establish the IPsec tunnel to a server as the transfer destination of the packet (step S206).

In the IKE negotiation in step S206, the server and VPN gateway A21 authenticate each other; the VPN gateway A21 compares the issuer CN of a certificate presented by the server with the entry registered in the packet relay table, and checks whether the certificate is permissible (step S207).

If it is determined in step S207 that the certificate presented by the server is permissible, the packet relay unit A214 relays and transfers the packet to the IPsec tunnel set on the LAN side (step S208).

If it is determined in step S207 that the certificate presented by the server is unpermissible, the packet relay unit A214 discards the packet (step S205).

Also, if it is determined in step S204 that the LAN-side IPsec tunnel to which the packet is to be transferred has already been established, the packet relay unit A214 relays and transfers the packet to the IPsec by skipping the procedure in steps S206 and S207 (step S208).

After that, communication is performed in this session by encrypting data by using an IPsec tunnel on both the WAN side and LAN side of the VPN gateway A21.

The foregoing is an explanation of the operation of relaying a packet between the WAN side and LAN side of the VPN gateway A21.

Although IPsec tunnels are used to transfer packets between the VPN gateway A21 and servers A131 to A136 in this embodiment, it is also possible to use another tunneling protocol, such as L2TP (used together with IPsec) or PPTP, having encryption and authentication mechanisms.

In addition, as explained in the first embodiment, this embodiment can also be carried out even in the case that the data center A2 does not exist in a single base but takes the form of a distributed data center.

The effects of this embodiment will be explained below.

In this embodiment, a packet communicated via the first VPN tunnel such as IPsec or L2TP set to form a VPN on the WAN side of the VPN gateway A21 is relayed via the second VPN tunnel such as another IPsec for relaying and transferring the packet in an interval from the VPN gateway A21 to a server on the LAN side. Since a VPN tunnel is thus used on the LAN side as well, it is possible to prevent misrepresentation as a server and wiretapping and tampering of communication.

### Third Embodiment

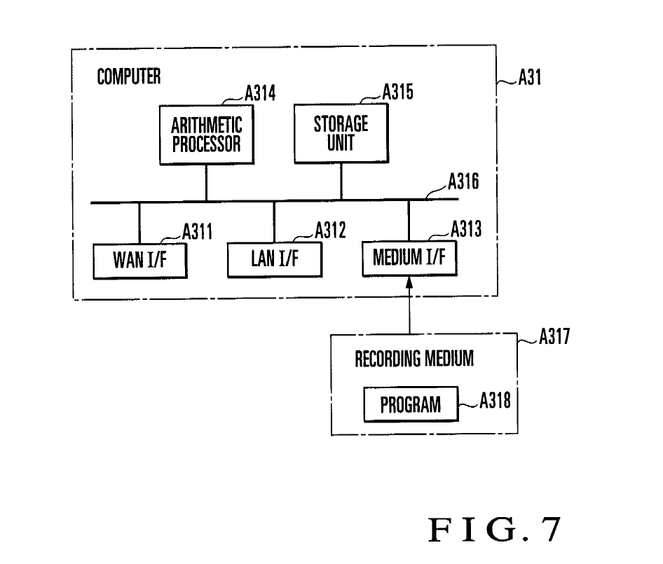

The functions of the VPN gateway device of the present invention can naturally be implemented by hardware, and can also be implemented by a computer and program. An embodiment that implements the VPN gateway device by a computer A31 and program A318 will be explained below with reference to FIG. 7.

The computer A31 has, e.g., an arrangement in which a bus A316 interconnects a WAN interface A311, LAN interface A312, medium interface (medium I/F) A313, arithmetic processor A314, and storage unit A315. The program A318 is provided as it is recorded on a computer-readable recording medium A317 such as a magnetic disk or semiconductor memory. When the recording medium A317 is connected to the medium interface A313, the program A318 is stored in the storage unit A315. The arithmetic processor A314 reads out the program A318 stored in the storage unit A315, and operates in accordance with the program A318, thereby implementing the WAN interface 111, LAN interface A112, IPsec processor A113, session relay unit A114, session relay table storage unit A115, and SSL processor A116 in the first embodiment described above, and the WAN interface A211, LAN interface A212, IPsec processor A213, packet relay unit A214, and packet relay table storage unit A215 in the second embodiment described above.

Although the embodiments of the present invention have been explained above, the present invention is not limited to the above embodiments, and various additions and changes can be made.

1. A VPN gateway device characterized by comprising:
a WAN interface which exchanges packets with a client node via a VPN tunnel set on a WAN side;
a LAN interface which exchanges packets with a server node connected to a LAN side;
a session relay unit which temporarily terminates a first communication session to be set for said server node from said client node, and sets, for said server node, a second communication session which relays the first communication session; and
an SSL processor which makes the second communication session set by said session relay unit into an SSL.

2. A VPN gateway device according to claim 1, characterized by further comprising a storage unit which stores, for each destination information, information indicating whether to permit session relay,
wherein said session relay unit comprises:
a determination unit which refers to the information stored in said storage unit, and determines whether relay is permitted on the basis of destination information of the first communication session; and
a session processor which disconnects the first communication session by performing TCP resetting for the first communication session if relay of the first communication session is not permitted, and sets the second communication session if relay of the first communication session is permitted.

3. A VPN gateway device according to claim 1, characterized by further comprising a storage unit which stores, for each destination information, information indicating whether to make a session into an SSL when relaying the session,
wherein said session relay unit comprises:
a determination unit which refers to the information stored in said storage unit, and determines whether to make the second communication session into an SSL on the basis of destination information of the first communication session; and
a session processor which does not make the second session into an SSL if said determination unit determines not to make the second communication session into an SSL, and makes the second communication session into an SSL if said determination unit determines to make the second communication session into an SSL.

4. A VPN gateway device according to claim 1, characterized in that said session relay unit comprises:
an authentication unit which authenticates said server node on the basis of an issuer of a server certificate transmitted from said server node, in SSL handshake for setting the second communication session; and
a session processor which disconnects the first communication session and the second communication session by performing TCP resetting for the first communication session and the second communication session, if authentication of said server node is unsuccessful.

5. A VPN gateway device characterized by comprising:
a WAN interface which exchanges packets with a client node via a first VPN tunnel set on a WAN side;
a LAN interface which exchanges packets with a server node connected to a LAN side; and
a packet relay unit which relays and transfers to said server node a packet addressed from said client node to said server node and received by said WAN interface, via a second VPN tunnel set between said LAN interface and said server node.

6. A VPN gateway device according to claim 5, characterized by further comprising a VPN processor which sets the second VPN tunnel upon receiving a packet from the first VPN tunnel.

7. A VPN gateway device according to claim 5, characterized by further comprising a storage unit which stores, for each destination information, information indicating whether to permit packet relay,
wherein said packet relay unit comprises:
a determination unit which refers to the information stored in said storage unit, and determines whether relay is permitted on the basis of destination information of the packet received by said WAN interface; and
a session processor which discards the packet received by said WAN interface if relay is not permitted, and relays and transfers the packet if relay is permitted.

8. A VPN gateway device according to claim 5, characterized in that said packet relay unit comprises an authentication unit which authenticates said server node on the basis of an issuer of a server certificate transmitted from said server node, in a protocol procedure for setting the second VPN tunnel.

9. A VPN gateway device according to claim 5, characterized in that the second VPN tunnel is associated with a VPN formed by the first VPN tunnel, and, if a plurality of VPNs exist, a plurality of second VPN tunnels associated with the VPNs are set for the same server node, thereby accommodating said server node in said plurality of VPNs.

10. A hosting system characterized by comprising:
a VPN gateway device which terminates a VPN tunnel set on a WAN side; and
a server node connected to a LAN side of said VPN gateway device,
wherein said VPN gateway device comprises:
a WAN interface which exchanges packets with a client node via the VPN tunnel;
a LAN interface which exchanges packets with said server node;
a session relay unit which temporarily terminates a first communication session to be set for said server node from said client node, and sets, for said server node, a second communication session which relays the first communication session; and
an SSL processor which makes the second communication session set by said session relay unit into an SSL.

11. A hosting system according to claim 10, characterized in that said session relay unit comprises:
an authentication unit which authenticates said server node on the basis of an issuer of a server certificate transmitted from said server node, in SSL handshake for setting the second communication session: and
a session processor which disconnects the first communication session and the second communication session by performing TCP resetting for the first communication session and the second communication session, if authentication of said server node is unsuccessful.

12. A hosting system characterized by comprising:
a VPN gateway device which terminates a first VPN tunnel set on a WAN side; and
a server node connected to a LAN side of said VPN gateway device,
wherein said VPN gateway device comprises:
a WAN interface which exchanges packets with a client node via the first VPN tunnel;
a LAN interface which exchanges packets with said server node; and
a packet relay unit which relays and transfers to said server node a packet addressed from said client node to said server node and received by said WAN interface, via a second VPN tunnel set between said LAN interface and said server node.

13. A hosing system according to claim 12, characterized by further comprising a VPN processor which sets the second VPN tunnel upon receiving a packet from the first VPN tunnel.

14. A hosting system according to claim 12, characterized in that said packet relay unit comprises an authentication unit which authenticates said server node on the basis of an issuer of a server certificate transmitted from said server node, in a protocol procedure for setting the second VPN tunnel.

15. A hosting system according to claim 12, characterized in that the second VPN tunnel is associated with a VPN formed by the first VPN tunnel, and, if a plurality of VPNs exist, a plurality of second VPN tunnels associated with the VPNs are set for the same server node, thereby accommodating said server node in said plurality of VPNs.

16. A program which causes a computer to implement:
a WAN interface which exchanges packets with a client node via a VPN tunnel set on a WAN side;
a LAN interface which exchanges packets with a server node connected to a LAN side;
VPN processing means for terminating the VPN tunnel;
storage means for storing a session relay table which holds, for each VPN, a correspondence of the VPN tunnel to a VLAN set on the LAN side, and holds, for each VLAN, a destination IP address and destination port information of a packet, necessity of making an SSL, and certificate issuer information required to make an SSL; and
session relay means for temporarily terminating a first communication session to be set for said server node from said client node, and setting, for said server node, a second communication session which relays the first communication session, as an SSL session, by referring to the session relay table stored in said storage means.

17. A program which causes a computer to implement:
a WAN interface which exchanges packets with a client node via a first VPN tunnel set on a WAN side;
a LAN interface which exchanges packets with a server node via a second VPN tunnel set on a LAN side;
VPN processing means for terminating the first VPN tunnel and the second VPN tunnel;
storage means for storing a packet relay table which holds, for each VPN, a correspondence of the first VPN tunnel to the second VPN tunnel, and holds, for each second VPN tunnel, a destination IP address and destination port information of a packet and certificate issuer information; and
a packet relay unit which relays and transfers, via the second VPN tunnel to said server node, a packet addressed from said client node to said server node and received by said WAN interface, by referring to the packet relay table stored in said storage means.
